(19) United States
(12) Patent Application Publication
(10) Pub. No.: US 2004/0230661 A1
(43) Pub. Date: Nov. 18, 2004

(54) Rules based notification system

(76) Inventors: Gus Rashid, Middletown, NJ (US); Navruze Rashid, Highlands, NJ (US); Boris Gitlin, Brooklyn, NY (US)

Correspondence Address: Richard C. Woodbridge, Esq., Synnestvedt Lechner & Woodbridge, LLP, P.O. Box 592, Princeton, NJ, 08542-0592, US

(21) Appl. No.: 10/767,085

(22) Filed: Jan. 29, 2004

Related U.S. Application Data
(60) Provisional application No. 60/443,629, filed on Jan. 29, 2003.

(51) Int. Cl. G06F 15/16

(52) U.S. Cl. 709/207

(57) ABSTRACT

A system and method of generating and transmitting notifications from a server to specific, remote users via a network and a client device currently associated with the user. User information obtained at login may be used in registering the current user/device association. The notification uses pre-encoded rules, understood by both a server side run time component and an associated client side run time component. The pre-encoded rules may specify all the necessary parameters of the notification and its transmission and improve performance on a wireless network. The improved wireless network performance is achieved, in part, by reducing the amount of data transferred and reducing the need for multiple client-server interactions in a single notification. The rules also help ensure synchronization of client and the server information databases and may also specify the scheduling of the notification and the information to be optionally updated in the database.

### CROSS REFERENCE TO RELATED APPLICATIONS

This application claims the benefit of U.S. Provisional Patent Application Serial No. 60/443,629 filed on Jan. 29^{th}, 2003 entitled “Rules Based Notification System” by Gus Rashid, Navruze Rashid and Boris Gitlin, the entire contents and substance of which are hereby incorporated by reference.

### FIELD OF THE INVENTION

The present invention relates to systems and methods of transmitting notifications from a server to a specific, remote user, and to applications associated with that user, over a network, and particularly to notifications having content and transmittal parameters determined by a predefined set of rules customized for a wireless network.

### BACKGROUND OF THE INVENTION

Getting information to mobile workers in a timely manner is an important reason why organizations are deploying wireless networks. The goal is to improve mobile workers' productivity by getting them near-real time information on their jobs, including, for instance, new jobs, cancelled jobs and altered priorities or parameters for jobs in progress. The ability to dispatch detailed and updated work orders to a technician closest to a customer in near real-time maximizes the productivity of a field service team, allowing technicians to complete more jobs per month and to respond to customer needs more quickly and effectively.

Most organizations deploying wireless networks already use applications operating on the Internet, or a fixed corporate network, to integrate data distribution to and from their non-mobile users.

With the arrival of General Packet Radio Service (GPRS) in the mobile communications area, it would seem as if all these applications and services already being used by organizations and already running on the fixed Internet should immediately become available to the mobile user. After all, GPRS essentially involves overlaying a packet based air interface on the existing circuit switched Global System for Mobile Communication (GSM) network so that, in principal, any service or application used on the fixed Internet should be immediately available over the wireless network.

However, there are significant problems migrating Internet applications to GPRS networks. These include the fact that GPRS networks use Dynamic Host Configuration Protocol to assign Internet Protocol (IP) addresses to devices. While optimizing the network providers use of resources, it means that a given device can change it's IP address frequently throughout the day. For instance, as mobile devices roam in and out of coverage, or are in inactive for a time, or the device is restarted, the IP address will change. Internet based applications are mostly stateless and not designed for situations where the IP address changes while the application is running. Wireless applications with time-critical dispatch requirements need some mechanism to keep user sessions active, regardless of frequent disconnects and changing IP addresses, or some other means to ensure that data on the server remains synchronized with data on the client.

In addition, although GPRS claims to be an “always on” network, this is only true from the device's perspective, it is not true from the server application's perspective. GPRS operators implement a timeout for active sessions, which may as short as five minutes. If there is no data exchanged between the client and the server for this period, the connection is dropped and the IP address is reassigned to another device. The server application cannot reestablish the connection, and therefore cannot push data to the client until the client reconnects with the server. If there is no process on the client to maintain or re-establish a connection with the network, the mobile worker becomes unreachable by the server application after the timeout.

A further problem is caused by latency. The latency of a typical corporate LAN is less than 10 ms, whereas typical GPRS latencies are closer to 800 ms. This can have a big impact on the performance of applications that need to exchange data with the server many times in a short period. For instance, browser-based applications require a Transmission Control Protocol (TCP) handshake for a Hyper Text Transmission Protocol (HTTP) request to open a socket and another to close the socket. In addition, many line-of-business applications require complex database transactions involving several exchanges between client and server. These applications may transmit more data over a wireless network than necessary due to expired TCP timers and frequent re-transmissions resulting in slow response times. Interactive programs are particularly affected.

Organizations needing to transmit data over a wireless network, especially data that needs to be synchronize by interactive updating, find it is highly desirable to have client/server applications that perform well despite the shortcomings of wireless net works detailed above. In particular, notifications to remote users, and remote user applications, need to convey information in as near to real time as possible, reliably, efficiently and in a way that ensures that the information on both the client and the server remain synchronized with each other.

### SUMMARY OF THE INVENTION

The present invention is a system and method of generating and transmitting a notification from a server to a specific, remote user via a wired or wireless network. The notification of the present invention is transmitted to one or more client devices currently associated with the user and may also be used with applications running on that client device.

In the preferred embodiment of the invention, the notification overcomes the problems associated with a wireless network by making use of pre-encoded rules, understood by both a server side run time component and an associated client side run time component. The rules are designed to, for instance, reduce the amount of data transferred by eliminating the need for formatting or interpreting the data; to reduce the need for multiple client-server interactions in a single notification and to ensure that the information on both the client and the server remain synchronized with each other.

In the preferred embodiment, the user/client device association may, for instance, be established as part of the device's login procedure. The user information obtained at login, such as user name and password, may also be used in registering the current user/device association with the server.

The notification to be sent to the user is generated on the server by a process having pre-encoded rules and includes a set of data selected from an application database. The pre-encoded rules specify all the necessary aspects of the notification and its transmission including, but not limited to, the conditions that determine the notification generation, the type of notification, the criteria that determine whether a notification is to be sent, whom it is to be sent to, the content of the notification, including static and dynamic elements, and from which database and database elements the content data set is to be obtained. The rules may also specify the scheduling of the notification and the information that may be optionally updated in the database when the notification is sent.

### BRIEF DESCRIPTION OF THE DRAWINGS

FIG. 1 depicts the topology of hardware and software deployment as pertains to the preferred embodiment for the present invention.

FIG. 2 describes, by means of a flowchart diagram, the high level process pertaining to generation of an RBN-enabled mobile application as well as installation, configuration and operation of same, as pertains to the present invention.

FIG. 3 describes, by means of a flowchart diagram, the process of operating an RBN application within the mobile device by the user.

FIG. 4 describes, by means of an interaction state-chart diagram, the process by means of which the client and server perform the sync process using the push mechanism.

FIG. 4A describes, by means of an interaction state-chart diagram, the process by means of which the client and server perform the sync process using the polling mechanism.

FIG. 5 provides a detailed flowchart of the push-based notification process within the client.

FIG. 5A provides a detailed flowchart of the poll-based notification process within the client.

### DETAILED DESCRIPTION

The present invention will now be described in more detail by reference to the drawings in which like numbers refer to like elements. An appendix containing definitions of the technical terms used, and examples of specific instances of many of the components described, is attached at the end of the detailed description.

The present invention is a system and method of generating and transmitting a notification from a server to a specific, remote user via a wired or wireless network. The notification of the present invention is transmitted to one or more client devices currently associated with the user and may also be used applications running on that client. In the preferred embodiment of the invention, the notification overcomes the problems associated with a wireless network by making use of pre-encoded rules, understood by both a server side run time component and an associated client side run time component.

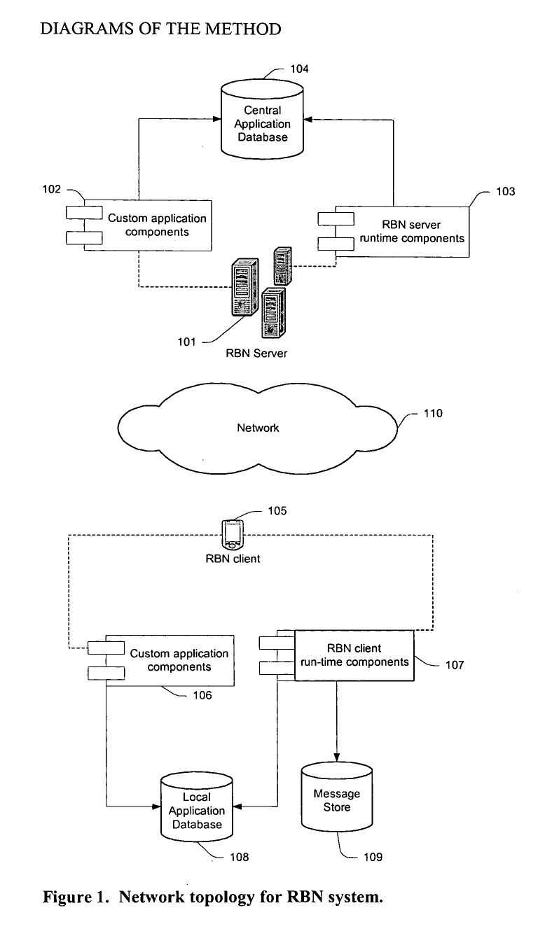

FIG. 1 is a diagram illustrating a suitable architecture for implementation of an exemplary embodiment of the inventive concepts of the present invention. A Rules Based Notification (RBN) server (101) is made available on a network (110). At least one custom application component (102) and at least one RBN run-time component (103) are installed on the server (101) in such a way that they are all able to access a central application database (104), which contains schema and other entities specific to the custom application. These schema may for instance be, but are not limited to, rules and the code for implementing the rules, that test for, for example, allowable and excludable types of data for specific fields in a document or database. The other entities may include, but are not limited to, the data itself.

A client (105) is configured with at least one custom application component (106) and at least one RBN run-time component (107), both of which have access to a local application database (108) containing schema and other entities specific to the custom application. The custom application components (106) installed on the client (105) correspond to the same custom application for which custom application components are installed on the server, and the code for which have been generated by means of a Mobile Development Environment (MDE) or other software production tool.

Additionally, there is also a message store (109) installed locally on the device, which is accessed by the RBN client run-time components (107) in order to store information about delivered notifications.

The client (105) is able to communicate with the server (101) by means of a network (110), either directly by means of a network or wireless network card (not shown) or dialup modem, or through a proxy connection through a host workstation to which it is connected by means of a direct serial or infrared or other connection.

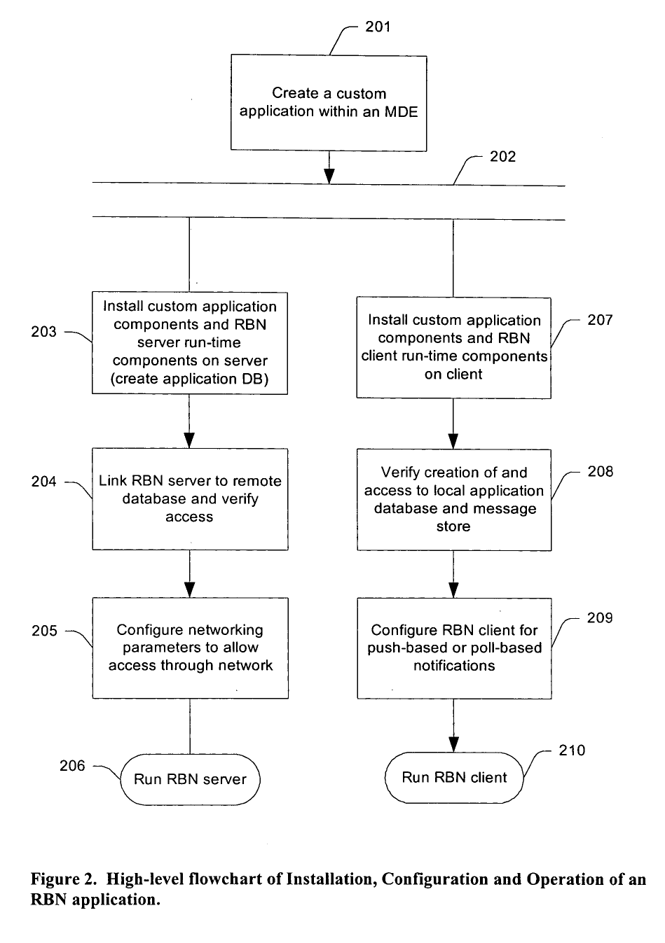

FIG. 2 illustrates a further level of detail by means of which the client and server are installed with a custom application and RBN run-time components, according to an embodiment of the present invention.

A custom application is generated within a software development tool, such as a Mobile Development Environment (MDE (201) with parameters specific to the hardware and software configuration present within the client device (105) and the server (101), so it may execute properly on both.

Item (202) denotes that the following steps may be followed in parallel: 203-206, and 207-214.

On the server (101), in step (203) the RBN server run-time components and custom application components are installed, including all necessary application database schema. Then, in step (204) the server is linked to the application database and access verified, i.e. connectivity and requisite access permissions are checked. Next, in step (205), the server (101) is configured to allow the client machines and/or client devices (105) to gain access via the network. Finally, in set (206) the RBN server application is run.

On the client (105), the RBN client run-time components (107) and custom application components (106), including any necessary user interface components, are installed in step (207). Then, in step (208), the existence of, and connectivity to, the local application database and message store is verified. Following this, in step (209), the RBN client is configured for a push or poll based method of notification, and the networking parameters are set. Finally, in step (210), the RBN client application (RBND) may be run.

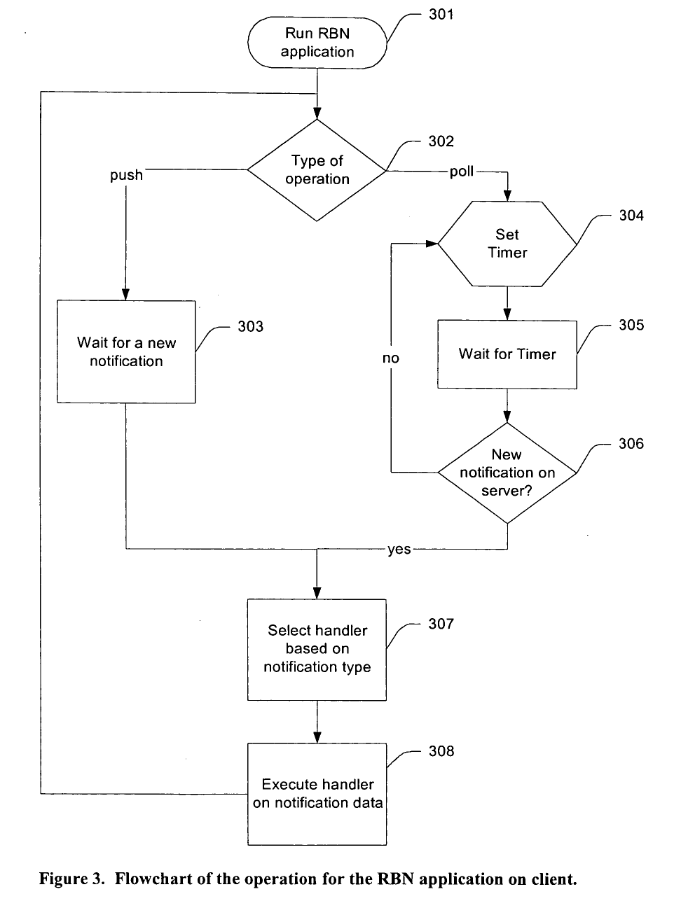

FIG. 3 shows the processing of the client application within the RBN process. In step (301), the application is started. In the next step (302), the type of operation is determined. If the operation type is determined to be push-based, then the client proceeds to step (303) where it enters a state of waiting indefinitely for a notification from the message queuing mechanism that a message has been delivered.

If instead the operation type is determined to be a pull-based operation, the application proceeds to step (304) in which a timer is set. The application then proceeds to step 305 in which it waits for the expiry of the timer. Once an expiration of the time is detected, the application proceeds to step (306) in which it queries the server for new notifications addressed to the current client. If there are no new notifications, then processing loops back to step (304) and the timer is set again.

If a notification is detected by the application, either in push operation step (303) or in poll operation step (306), the application proceeds to step (307) in which a notification handler is selected to process the notification message, based on the notification type, which may for instance be, but is not limited to, a text message or a Uniform Resource Locator (URL). If the notification is a text or text box message, the handler selected may for instance be a pop-up dialog to display the message, whereas if the notification is a URL, the notification handler selected may for instance be a Microsoft Pocket Internet Explorer Browser. In step (308), the selected notification handler is run. After the notification handler has processed the notification, the application loops back to step (302). Processing continues indefinitely, until the process is ended by some means such as, but not limited to, the device being turned off by the user.

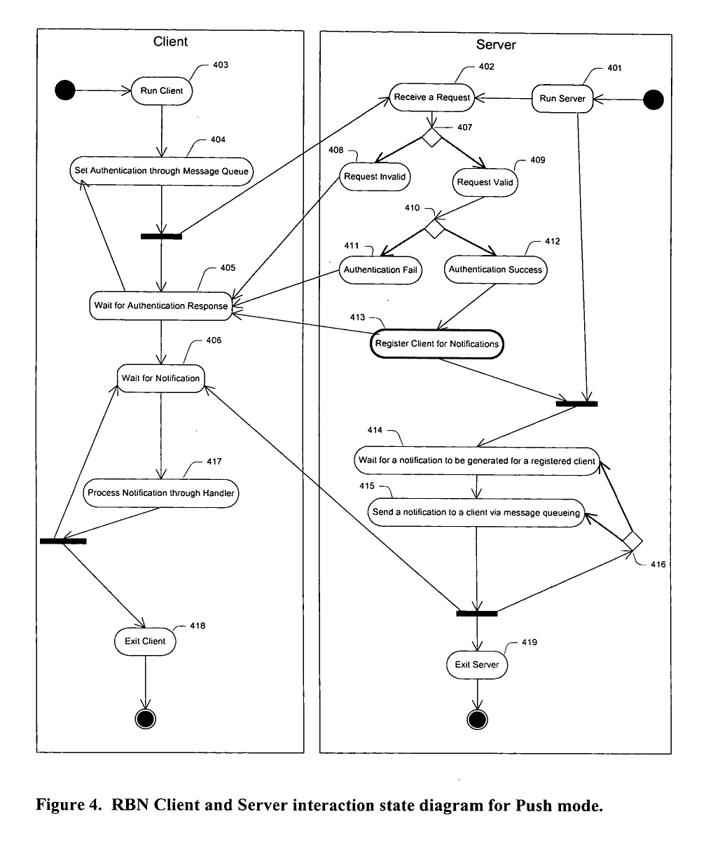

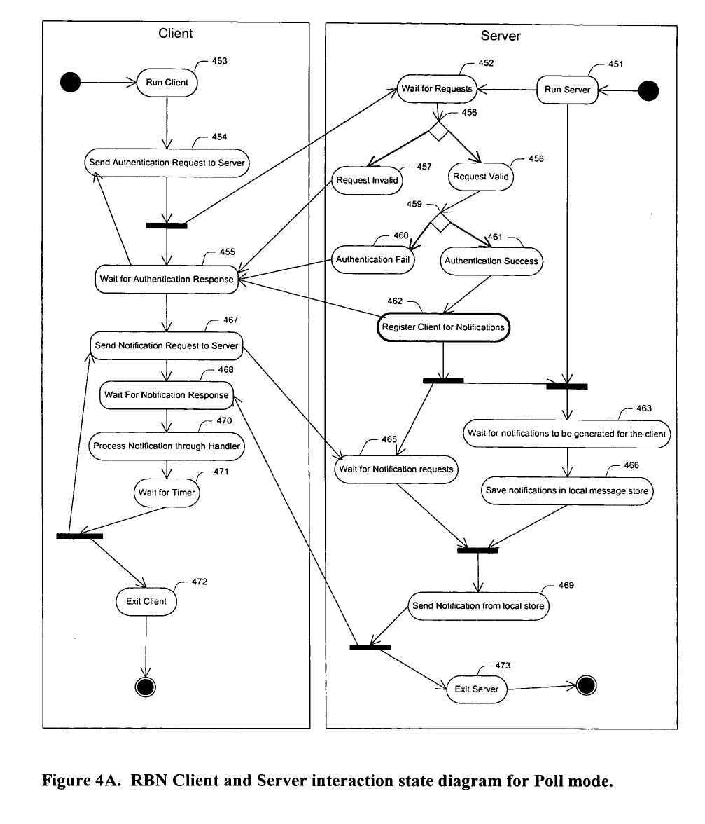

FIGS. 4 and 4A are interaction state chart diagrams, illustrating the interactions and resulting states on both the client and the server during the notification process, for push and poll based methods, according to a preferred embodiment of the present invention.

As shown in FIG. 4, in the push-based process, the server (101) is set running in step (401) and proceeds initially to state (402) in which it is ready to receive a request from a client. The client (105), or client process, is started in step (403) and proceeds to step (404) in which it attempts to set authentication through the message queue. Setting the authentication includes sending an authentication request to the server, containing information such as, but not limited to, user name, password and device identification, as well as the time of request. The client then goes into a state (405) in which it waits for an authentication response from the server. The responses received from the server indicate that the attempt to set the authentication either was invalid, the authentication failed or the authentication succeeded and the client is registered for notifications. If the response is either that the authentication request was invalid or that it did not succeed, the client may return to state (404) and re-attempt to set the authentication through the message queue. If the authentication response received indicates that the client is registered for notifications, the client then proceeds to state (406) and waits for a notification.

On the server, when the process being executed by the server, i.e. the server process, receives a request in step (402), it then proceeds to perform the following evaluations: firstly, in step (407) it determines whether the request is a valid one as defined by the semantic conventions listed as part of the format for the request in the pre-encoded rules. If the request is invalid, the server process proceeds to state (408) in which it sends a response to the client indicating that the request was invalid. If the request is valid, the process goes to state (409) and then proceeds to the next evaluation, authentication evaluation (410).

At authentication evaluation (410), the server process tests whether an encrypted authentication token embedded within the client request is valid. If the authentication evaluation (410) fails and state (411) is reached, the server process sends a response to the client, which informs the client process that the authentication for the current user has failed. If it the evaluation succeeds and state (412) is reached, the server process then proceeds to step 413 in which it registers the client for notifications, sends a message to the client informing the client that it has been registered for notifications and then proceeds to process (414) in which it wait for notifications to be generated for registered clients. Server (101) may be a multithreaded application, in which case process (414) may already be running in parallel for other clients which have already been registered directly following execution or start up of the server in step (401).

When a notification is generated for a registered client, the server proceeds to send the notification to the client via message queuing in step (415) utilizing an appropriate message queuing application. Examples of such message queuing applications include but are not limited to Microsoft Message Queue (MSMQ) or Broadbeam ExpressQ ®. The server then goes to evaluation (416) in which it evaluates whether there are additional notifications that have been generated for registered clients.

If there are additional notifications, the server continues to step (415) and sends the next notification to the destination client, otherwise it proceeds to step (414) and waits for the next notification to be generated.

On the client side, when the client process waiting for a notification in state (406) receives a notification from the server, it then determines which message handler has been registered for processing the given type of notification and proceeds to step (417) in which it executes or processes the notification through the selected notification handler.

At any point the client can exit processing through state (418) or the server may exit processing through state (419). If the client exits through state (418), the server continues queuing notifications until the client process is re-run. If the server exits through state (419), then notifications will not be queued and notifications generated while the server is not running will be ignored.

As shown in FIG. 4A in the poll-based process, the server is started in step (451) and then proceeds to state (452) in which it is ready for a request from a client. The client, or client process, is started in step (453) and proceeds to step (454) in which it sends an authentication request to the server. The authentication request contains information such as, but not limited to, user name, password and device identification, as well as the time of request. The client then goes into a state (455) in which it waits for a response to the authentication request from the server. The authentication response is a message from the server telling the client the server's decision. This decision may be that the request was found to be invalid, that the request was in valid form but found not to be authenticated or that the request was valid and authenticated that the client has now been registered for notifications. In the event of the server informing the client that the request was either invalid or not authenticated, the client may return to state 454 and send a further authentication request.

On the server, when the process being executed by the server, i.e. the server process, receives a request in state (452), it then proceeds to perform the following evaluations: firstly, in validation evaluation (456), it determines whether the request is a valid one as defined by the semantic conventions listed as part of the format for the request in the encoded rules. If the request is invalid, the process enters state (457) in which the server process sends a response to the client informing it that the request is invalid. If the request is valid, the sever process enters state (458), from which it then proceeds to the next evaluation, the authentication evaluation (459).

In authentication evaluation (459), the server process tests whether the encrypted authentication token embedded within the client request is valid. If the authentication evaluation (459) fails, the server process enters state (460) it which it sends a response to the client, informing the client process that the authentication for the current user has failed. If it the evaluation succeeds, the server process passes through state (461) of noting that the authentication was successful to state (462), in which it registers the client for notifications and sends a message to the client informing it that it is registered for notifications. Having done that, the server process proceeds to state (463) in which it waits for notifications to be generated for registered clients. When notifications are generated for registered clients and detected by state (463), the server initiates state (466) in which it stores the message in a local message store.

The server process may be implemented as a multi-threaded process, in which case process (463) may already be running in parallel for other clients that have already been registered directly following execution or start of the server in step (451).

Additionally, the server sets up state (465) in parallel to state (463). In state (465), the server process waits for notification requests from clients.

On the client side, if state (455) detects a successful response to the client sides authentication request (455), the client then proceeds to state (467) in which it sends a request for notifications for the current user to the server. On successful sending the request for notification message, the client process enters state (468) of waiting for a response from the server.

On the server side, if there is a notification awaiting the specific user, the server proceeds to state (469) in which it sends the client a response containing a notification from the message store (469). When the client receives the response, it enters state (470) in which it processes the notification message using the appropriate handler. After processing the message, the client process sets a timer, and enters state (471) in which it waits for the timer to expire. When a timer expiration is detected, the client process enters state (467) in which it sends a next request to the server for notifications for the current user.

If an exit signal is received, the client enters state (472) in which it then exits the process. In this case of a client process exit, the server continues processing notifications and saving them in the local store for transmission the next time the client process is run and requests notifications.

Similarly, the server process may at any time enter state (473) and exit. However, in this case of a server process exit, notifications are not generated until the server starts up again.

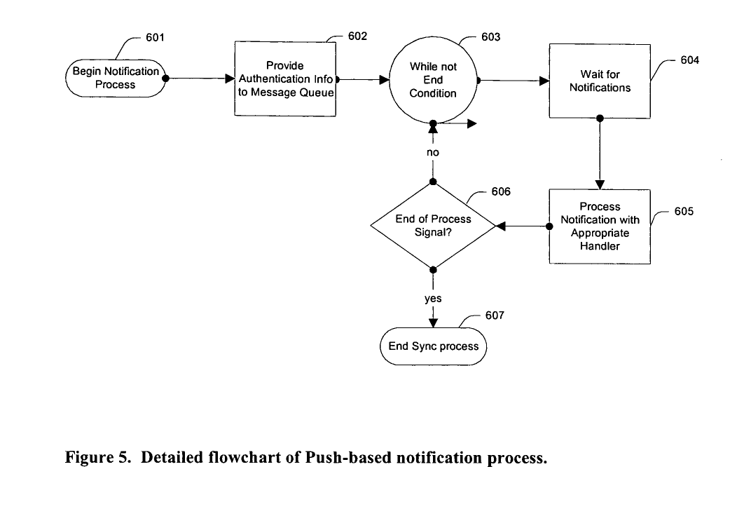

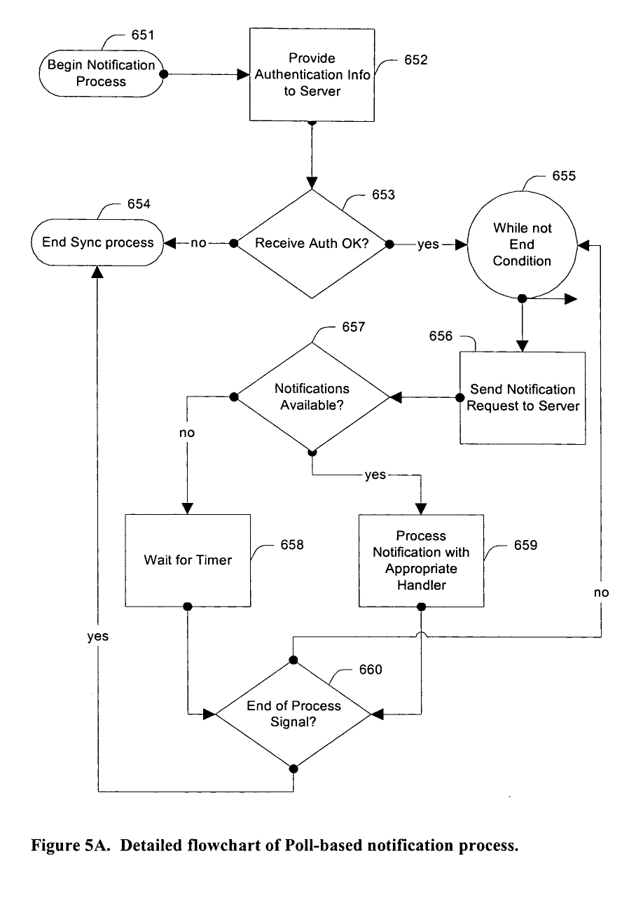

FIG. 5 shows a flowchart diagram of the push-based notification process as performed on the client, according to an embodiment of the present invention. The notification process is begun as step (601). The client process then proceeds to step (602) in which it provides authentication information to the message queuing mechanism in use to obtain notifications from the server. The process loops indefinitely through steps (603), (604) (605) and (606) until an end condition is met.

During this looping, the following actions occur. In step (604), the client waits for a notification to arrive within the message queuing mechanism and alert it to its arrival. If a notification is received, the process goes to step (605) in which it locates the appropriate handler for the message type and processes the notification using the handler. If an end of process signal is detected in step (606), the process exits in step (607). Otherwise, it proceeds back to the iteration loop end condition detector step (603). If no end condition is detected, the process goes to step (604) and waits for another message notification.

FIG. 5A is a flowchart of the poll-based notification process as performed on the client, according to a preferred embodiment of the present invention. Within the poll-based process, the client starts up in step (651) and proceeds to step (652) in which it sends an authentication request directly to the server, rather than to the message queuing mechanism as in the related push-based mechanism step (602). The server responds immediately to the request, and in step (653) the client tests whether the authentication information has been accepted.

If the authentication information is invalid, then the process ends via step (654). Otherwise, if the authentication is valid, the client proceeds to process notifications as follows. While an end condition is not detected in step (655), the process iterates through the notification process for notification received. First, in step (656), the client process sends a notification request to the server.

The server responds with notifications if available, or a message denoting that there are no notifications. In step (657) he client tests whether or not a notification has been received. If the client determines that a notification has not been received, a timer is set and the process proceeds to step (658) in which it waits for the timer to expire. If, on the other had, the client determines that a notification has been received, it proceeds to step (659) in which the notification is processed by an appropriate handler. When either a timer expiration is detected in step (658) or the notification handing of step (659) is completed, execution continues to step (660), in which the client process checks whether an end of process signal has been received. If an end of process signal is received, the process execution terminates and the process exits in step (654). Otherwise, processing loops back to step (655) and iterates through any further notifications.

In the preferred embodiment of the invention, transmission of the notification to the server is done by a transport layer adapted to the type of network being used, and may use commercially available message queuing application such as, but not limited to, Microsoft's Message Queue (MSMQ) or Broadbeam's Express™.

Depending on the nature of the notification and the type of network being used, the notification may either be pushed from the server to the client device, or it may be polled from the server by the client device.

In the preferred embodiment of the invention, the client device includes a push-configurable, run-time-component. In the push-configuration the client run-time-component is capable of waiting for a notification sent from the server by an associated run-time-component running on the server. The client device run time component is also poll-configurable. In the poll configuration, it is capable of setting a timer; waiting for an expiration of the timer; and, on detecting the expiration of the time, querying the related server for any notifications produced by the server-side, associated run-time-component that are waiting to be delivered.

In the preferred embodiment, the encoded rules include the capability to specify the type of notification, which may for instance be, but is not limited to, a text message or a Uniform Resource Locator (URL). Based on the type of message, the client-side run-time-component is able to select a notification handler to display the notification. For instance, if the notification is a text or text box message, the client run-time-component may select a pop-up dialog to display the message, whereas if the notification is a URL, a Pocket Internet Explorer Browser may for instance be selected and re-directed to the URL to display the information accessible there.

The run-time-components incorporating the inventive concepts of this invention may be instantiated in the form of software objects. These objects may include, for instance, Data Abstraction Layer (DAL) objects suitable for implementing the rules defining database models, the relevant fields to be accessed in those models, and the relationships between the fields, the DAL object and other objects such as, but not limited to, authentication objects. The DAL may also include methods that allow the rules based notification to include statements such as, but not limited to, SELECT and UPDATE statements, that allow the notification to interact with the data sources including, but not limited to, the application database. This interaction may occur before and/or after the notification is transmitted and may require user interaction.

In the preferred embodiment the run-time-component on the client device includes preset formatting rules for displaying notifications thereby eliminating the need to transmit formatting information along with the data as is necessary in, for instance, well known Hyper-Text Markup Language (HTML) documents commonly used on wired networks.

In a further embodiment, the RBN client and server may include an optional retry authentication mechanism that forces the client to re-send authentication information to the server at a specified or variable interval. This process keeps the client registration list on the server current. Thus, when a client is no longer using the RBN system, the server registration expires gracefully and notifications for that client are no longer generated. In addition, the retry authentication mechanism closes possible security loopholes, including the loophole whereby, when a client's authentication information changes on the server, the client is forced to re-send the updated authentication information. The retry authentication mechanism prevents an unauthorized user, who gains access to an authenticated device, from continuing to receive notifications once the user resets his password

While the invention has been described with reference to the preferred embodiment thereof, it will be appreciated by those of ordinary skill in the art that modifications can be made to the structure and elements of the invention without departing from the spirit and scope of the invention as a whole.

### Appendix I: Definitions.

To facilitate a clear understanding of this invention, definitions of terms employed herein follow:

A network refers to a TCP-IP based data transport mechanism over which software may exchange data.

Examples of networks as pertain to this invention include but are not limited to Local Area Networks (LAN), Wide Area Networks (WAN) (e.g. the Internet), Wireless Local Area Network (WLAN) (e.g. 802.11a and 802.11b networks), and wireless networks such as CDPD, GSM and GPRS.

A data source or database refers to a source of data which may be accessed by software via network or locally to store, retrieve and index data.

Examples of such databases include but are not limited to RDBMS products such as Oracle, Sybase and Microsoft SQL Server. The definition may also include other data sources such as text files, Excel spreadsheets and data feeds from other software objects or vendors locally or across a network.

A client or mobile client or client device or client computer refers to computer hardware which is generally in possession of a user or mobile worker. The primary prerequisites for such a device to be considered a client computer or client device are (1) the ability for local data storage and retrieval through custom software as implemented within this embodiment, and (2) the ability for such a device to be able to communicate with a server (see below) either through a network or a local connection (such as a serial cable or infrared communication port). Examples of such clients include but are not limited to: workstations, laptop computers, PDAs such as Palm handheld computers, Windows CE/PocketPC based handheld computers or Symbian or other OS-based handheld computers, smart pager devices such as RIM Blackberry devices or smart phones employing Palm OS or PocketPC for Smart Phones OS.

A server or server machine or server computer refers to computer hardware which is able to access a database through a network, and is also available to be accessed by client computers (as in the definition above) over a network. Such network for client access may be, and is likely in most cases, distinct from the network for database access, generally for security purposes.

A notification refers to a specific set of data, which is generated on the server by means of rules encoded within a process. The data is created by any means possible within the server process, and is intended for a specific user, who may nor may not be associated with a specific client device or set of client devices.

A rules-based notification process or RBN process refers to a process whereby notifications are transmitted from the server to the client, and are appropriately presented to the user, whereby he or she may or may not perform additional actions based on the data. The users who are to receive notifications, and the contents of such notifications are based on rules which are executed on the server within generated rules components.

A push notification process is an RBN process which is invoked overtly by a process on the server and sent directly to the address of a client device or client machine. The notification data then appears on the client device by such store-and-forward and/or message queuing mechanism being employed. In this case, the user has associated himself or herself with a specific device or set of devices prior to the invocation of this process.

A polled notification process is an RBN process where the client executes a process periodically to check for notifications waiting for it on the server. In this case, the server does not actively send the data via message queuing, but rather stores the data until the client actively requests the data via the network. In this type of notification process, the user does not necessarily have had to associate himself or herself with a specific device or set of devices.

A transaction refers to the act of synchronization of at least one record between the client and server, with the a fail-safe provision whereby the sync process may be discovered to have failed, and the corresponding act of synchronization may be undone on both the client and server in order to restore both to the previous state, where the records are still identical though not updated.

RBN refers to a system of software, which enables Rules-Based Notifications on a mobile client from a server. This software comprises of 2 subsystems:

A set of run-time components which are binary, pre-compiled executable files installed on both the client and server in order to provide the code necessary to follow the notification process described within the invention herein (RBN run-time components or run-time components), and

An application or applications (custom application) which are generated through a separate Mobile Development Environment (MDE) or other generation process, which is aware of the RBN run-time components, and utilize the run-time components for local storage and cache-ing of data and data operations which are meant to be transmitted within an RBN process. These applications are specific to requirements as outlined by the user or user's organization and may perform any combination of tasks which the software developer might envision. They commonly, however, use the RBN run-time components and notification process. Components of a custom application need to be installed on both client and server machines in order for the invention to be enabled.

RBN server run-time components are RBN run-time components, which are installed on the server, and RBN client run-time components are RBN run-time components, which are installed on the client.

The RBND application is specifically installed on the client in order to provide the user with a means to retrieve messages through the RBN process, and handle them appropriately to the type of message.

An RBN client or RBN-aware client is a client that has the RBN run-time components installed and additionally may have custom applications installed which utilize the run-time components.

An RBN server or RBN-aware server is a server which has had the RBN run-time components installed and additionally may have custom application components installed which utilize the run-time components, and correspond to custom applications installed upon clients.

A central application database refers to a database which contains the master copy of the data for a custom application, and to which the RBN server is connected. This database contains application-specific schema based on the requirements of the custom application, and is accessed by the custom application components and the RBN server run-time components.

A message store refers to local storage on a client device or client machine, which stores a list of notifications received by the user on the client. This database is accessed by the RBN client run-time components on the client.

A schema refers to set of rule such as, for instance but not limited to XML schema which are a database-inspired method for specifying constraints on Extended Markup Language (XML) documents using an XML-based language. XML schemas address deficiencies in Document Type Definitions (DTD)s, such as the inability to put constraints on the kinds of data that can occur in a particular field (for example, all numeric). Since XML schemas are founded on XML, they are hierarchical, so it is easier to create an unambiguous specification, and possible to determine the scope over which a comment is meant to apply.

What is claimed is:

1. A notification generation and transmittal method, comprising:
associating a user with a client device;
registering said association with a server;
generating, on said server, a notification for said user, said notification including a set of data selected from an application database by a process having encoded rules; and,
transmitting said notification to said user via said client device.

2. The method as recited in claim 1 wherein said associating a user with a client device further includes authenticating said user.

3. The method as recited in claim 1 wherein said transmitting said notification further includes said client having a push-configured run-time-component capable of waiting for a notification.

4. The method as recited in claim 1 wherein said transmitting said notification further includes said client having a poll-configured run-time-component capable of setting a timer; waiting for an expiration of said timer; and, querying said server for said notification on detecting said expiration.

5. The method as recited in claim 1 wherein said encoded rules specify a type of notification and wherein said client device selects a notification handler to display said notification based on said type of notification specified.

6. The method as recited in claim 1 wherein said process having encoded rules includes at least one data abstraction layer object.

7. The method as recited in claim 1 wherein said application database is updated following said transmitting of said notification.

8. The method as recited in claim 1 where said client device handles said data set contained in said notification by means of a client application and said notification contains a statement enabling said client application to interactively query said application database.

9. The method as recited in claim 1 further including formatting said notification for display on said client device using one or more formatting rules incorporated into a run-time-component on said client device, said formatting rules operating independently of any interpretation of any symbols embedded in said set of data, thereby eliminating the need to transmit formatting information along with said set of data.

10. The method as recited in claim 1 further including packaging said notification by one or more packaging rules incorporated into a server run-time-component such that the data matches a form expected by a client run-time-component, thereby ensuring that one or more formatting rules incorporated into said client run-time-component, and operating independently of any data-related symbol-interpretation, can properly format said set of data for display on said client device.

11. A notification generation and transmittal apparatus, comprising:
a client device, said client device being associated with a particular user;
a server capable of registering said association between said client device and said particular user;
a notification for said user generated on said server, said notification including a set of data selected from an application database by a process having encoded rules; and,
a network capable of being used to transmit said notification to said user via said client device.

12. The apparatus as recited in claim 11 wherein said client further includes a push-configured run-time-component capable of waiting for a notification.

13. The apparatus as recited in claim 11 wherein said client further includes a poll-configured run-time-component capable of setting a timer; waiting for an expiration of said timer, and, querying said server for said notification on detecting said expiration.

14. The apparatus as recited in claim 11 wherein said encoded rules specify a type of notification and wherein said client device selects a notification handler to display said notification based on said type of notification specified.

15. The apparatus as recited in claim 11 wherein said notification is formatted for display on said client device using one or more formatting rules incorporated into a run-time-component on said client device, said formatting rules operating independently of any interpretation of any symbols embedded in said set of data, thereby eliminating the need to transmit formatting information along with said set of data.

16. A notification generation and transmittal device, comprising:
means for associating a user with a client device;
means for registering said association with a server;
means for generating, on said server, a notification for said user, said notification including a set of data selected from an application database by a process having encoded rules; and,
means for transmitting said notification to said user via said client device.

17. The device as recited in claim 16 wherein said client device includes a push-configured run-time-component capable of waiting for a notification.

18. The device as recited in claim 16 wherein said client includes a poll-configured run-time-component capable of setting a timer; waiting for an expiration of said timer; and, querying said server for said notification on detecting said expiration.

19. The device as recited in claim 16 wherein said process having encoded rules includes at least one data abstraction layer object.

20. The method as recited in claim 16 further including packaging said notification by one or more packaging rules incorporated into a server run-time-component such that the data matches a form expected by a client run-time-component, thereby ensuring that one or more formatting rules incorporated into said client run-time-component, and operating independently of any data-related symbol-interpretation, can properly format said set of data for display on said client device.
